(19) United States
(12) Patent Application Publication
(10) Pub. No.: US 2025/0314815 A1
(43) Pub. Date: Oct. 9, 2025

(54) DEVICE AND METHOD FOR THE HIGH-SPEED SWITCHING OF A SIGNAL IN MULTI-CORE FIBRES

(71) Applicants: UNIVERSIDAD DE CONCEPCION, Concepción (CL); UNIVERSIDAD CATÓLICA DE LA SANTÍSIMA CONCEPCIÓN, Concepción (CL)

(72) Inventors: Gabriel Alejandro SAAVEDRA MONDACA, Concepción (CL); Gustavo De Aquino MOREIRA LIMA, Concepción (CL); Stephen Patrick WALBORN, Concepción (CL); Jaime Andrés CARIÑE CATRILEO, Concepción (CL)

(21) Appl. No.: 18/881,622

(22) PCT Filed: Jun. 30, 2023
(86) PCT No.: PCT/CL2023/050054

§ 371 Date: Jan. 6, 2025

(30) Foreign Application Priority Data
Jul. 7, 2022 (CL) 1855-2022

(51) Int. Cl. G02B 6/02; G02B 6/35; G02F 1/125; H04B 10/2581

(52) U.S. Cl. CPC G02B 6/02; G02B 6/35; G02F 1/125; H04B 10/2581

(57) ABSTRACT

A device for high-speed switching of a signal propagating from a n core in a first fiber of the multi-core type to a m core in a second multicore fiber comprising: (a) a space-mode division module, responsible for splitting the input signal or signals into multiple spatial modes confined in the same multi-core fiber; (b) a spatial mode combination module, used to gather all copies of the signals propagating in the device and perform interference between them; and (c) a phase modulation module that is responsible for applying certain phases to each of the spatial modes of the system to manipulate the interference effect between the spatial modes in the spatial mode combination module, and in this way determine the output port of the signal to be switched. In addition, a method of operation of the device.

### TECHNICAL SECTOR

The technology is oriented to the communications area, more particularly, it corresponds to a method and a device for high-speed switching of a serial in multi-core fibers.

### STATE OF THE ART

Spatial mode multiplexing (SMD) in fiber-optic communications systems is one of the most promising solutions for increasing the information carrying capacity of these systems. Being one of the fibers with the greatest potential for the realization of SDM systems, multi-core fibers have multiple cores in which it is possible to transmit independent information signals. Despite the above, one of the problems to be solved in SDM systems based on multi-core fibers is the selection of a core for the transmission of information. Additionally, along multi-core fiber links and networks, flexibility is required to change the core in which information is carried from one fiber to another. This can be used to reduce or mitigate detrimental effects such as cross-talk between cores and modal dispersion between spatial modes and, in turn, this allows optimizing the use of the spatial resources of an SMD network and increasing its capacity to survive in the event of failures.

Nowadays, there is an interest in switching at high speed a signal propagating in a n core in a first multi-core fiber to a m core in a second multi-core fiber. The switching speed must be able to accommodate telecommunications signal transmission rates, which can range from 1 Gb/s to 800 Gb/s, or higher. To achieve these rates, commercial systems use optical pulse widths from 10 ps to 1 ns, corresponding to 100 and 1 GHz, respectively.

To achieve core switching in multi-core fibers, different alternatives have been proposed, mainly implemented in devices in which light is decoupled from the first multi-core fiber and, through free space optics, is redirected to the corresponding core of the second multi-core fiber. The main disadvantage of the existing proposals is the reduced switching speed they offer. A theoretical proposal to perform switching in multi-core fibers was presented by Zhou [1], however, it does not indicate alternatives for its implementation. The switching process between two multi-core fibers has been implemented using different technologies such as those proposed by Suzuki et al., Jinno et al., Shimakawa et al., Mulvad et al., Deakin et al., and Gadalla et al. [2, 5, 6, 7, 8 and 9] where liquid crystal over silicon (LCoS), antenna orientation (beam steering) and microelectromechanical systems (MEMS) are used to redirect the light beams to the second multi-core fiber. These proposals consist of redirecting beams of light using a material capable of responding to reconfigurable external stimuli. LCoS-based systems are composed of an optical subsystem responsible for decoupling light from the input medium to direct it towards the glass. LCoS media can change the angle of reflection of a light beam based on an applied voltage, typically with reconfiguration times on the order of ms. In this way, the redirected beam passes through a second optical system responsible for coupling the light with the output.

On the other hand, beam steering systems use an assembly consisting of a telecentric lens, a set of collimator lenses and a mirror. To switch the signals, a piezoelectric actuator capable of altering the angle of inclination of the collimator lenses must be controlled. This technology has reconfiguration times on the order of ms. Finally, MEMS-based systems consist of a free-space circuit formed by mirrors mounted on a movable base. The movement of the base can be controlled with electrical signals, allowing for switching of signals. The reconfiguration times of MEMS systems are on the order of ms. The systems mentioned above are used to switch signals in conventional optical fibers (single mode/core), so their adaptation for multi-core fibers requires additional components to be able to couple signals in this type of fibers.

In addition, the patents of Yan et al., Li et al. and Takahashi [10, 11 and 12] are also based on optical free-space systems such as those mentioned above to solve the problem described. In particular, the technology of Yan et al. [10] consists of a system and device capable of spatially and spectrally switching signals for multi-core fibers. To do this, it uses multiple wavelength selective switch (WSS) devices to route each of the signals to a port/core different from the system's output. WSS are devices built based on LCoS, so it has a reconfiguration time of the order of ms. The innovation of Li et al. [11] presents a generic photonic spatial mode processing system. This system is built in free-space optics, using an imaging system to collimate and couple the light to the photonic system. Although no processing speeds are reported for this system, it is expected that these will be in the order of ms due to the components used. Finally, Takashi et al. [12] presents a system for optical communications that can be applied to spatial multiplexing systems. This system is used to decouple and couple light from a spatial multiplexing fiber and, additionally, can be used to switch signals in the system. This system is based on free space optics and the use of a modulating element capable of reflecting light. This system has similar features to beam steering and LCoS switches, which have switching speeds in the order of ms.

From the above analysis, it can be deduced that none of the existing and proposed technologies based on free space optics have been able to work at telecommunications rates, due to the limitation in the switching speed in the order of ms. Therefore, during the process of reconfiguring the switch, information loss may occur.

One possible method to achieve increased switching speeds of devices is to perform this process in waveguides and/or within multi-core fibers. In addition, systems capable of carrying out switching between cores without the need for the use of free-space optics have been proposed, specifically the studies of Wang, R. et al. and Huo, L. et al. [3, 4]. These works present the use of long-period gratings etched inside the cores of the multi-core fiber. These gratings can achieve optical coupling between the cores of a multi-core fiber with the help of torsion applied to the fiber. By means of optical coupling, the signals are switched between different nuclei. The biggest drawback of these proposed systems is the need for mechanical components capable of applying torsion with high precision on the multi-core fibers, which limits both the switching speed of the device and the precision of the switching process.

Another proposal corresponds to the technology of Doerr et al., [14] which uses a photonic circuit designed in waveguides to process signals propagating through multi-core fibers, without the need to decouple the signals from each of the cores. This photonic circuit is based on waveguides that are directly linked to multi-core fibers, both in their input and output. The middle section of the photonic circuit corresponds to an integrated photonic circuit with signal processing capabilities. Where one of the processing options for a signal is core switching, however, no mechanism is specified to perform this process. Therefore, the switching speed and accuracy of the device is not reported.

Finally, the technology of X. Zhou et al. [13] presents a method and system for processing signals propagating to multiple spatial modes. This consists of changing the number of spatial modes to be able to couple fibers with different multiplicity of spatial modes to each other. This processing may include spatial switching of signals within its options. To perform core switching or spatial modes, it uses conventional technologies such as reconfigurable optical add/drop multiplexers (ROADMs).

Based on the aforementioned background, there is still a need to develop technologies that allow a signal to be switched at high speed in communications systems based on multi-core fibers.

### REFERENCES

[1] J. Zhou, “Power splitting and switching in a multi-core fiber based on the multimode interference effect,” Opt. Express 23, 22098-22107 (2015).
[2] K Suzuki et al., “Wavelength selective switch for multi-core fiber based space division multiplexed network with core-by-core switching capability”, 2016 21st OptoElectronics and Communications Conference (OECC) held jointly with 2016 International Conference on Photonics in Switching (PS). IEEE, 2016.
[3] Wang, R., Wu, Q., Tang, M., Fu, S., & Liu, D. “Reconfigurable inter-core switching within multicore fiber”. 2018 Optical Fiber Communications Conference and Exposition, OFC 2018—Proceedings, 1-3 (2018).
[4] Huo, L., Wang, R., Tang, M., Wu, Q., Fu, S., & Liu, D. “Reconfigurable Inter-Core Signal Switching within Multicore Fibers Based on Long-Period Gratings”.Journal of Lightwave Technology, 37(24), 6025-6032 (2019).
[5] M. Jinno, T. Kodama & T. Ishikawa, “Five-Core×Core Selective Switch and Its Application to Spatial Channel Networking” in Optical Fiber Communication Conference (OFC) 2020, OSA Technical Digest (Optical Society of America, 2020), paper M3F.3.
[6] O. Shimakawa, R. Kobayashi & H. Tazawa, “Low Loss Optical Switch with Precisely Rotationally aligned Multi-core fiber Array” in Optical Fiber Communication Conference (OFC) 2020, OSA Technical Digest (Optical Society of America, 2020), paper Th3B.7.
[7] H. C. H. Mulvad et al., “Beam-Steering All-Optical Switch for Multi-CoreFibers” in Optical Fiber Communication Conference, OSA Technical Digest (Optical Society of America, 2017), paper Tu2C.4.
[8] C. Deakin, M. Enrico, N. Parsons & G. Zervas, “Design and Analysis of Beam Steering Multicore Fiber Optical Switches” in Journal of Lightwave Technology, vol. 37, no. 9, pp. 1954-1963, 1 May, 2019.
[9] M. Gadalla, V. François, & B. Ung. “Realization of Multicore Fiber Reconfigurable Optical Add-Drop Multiplexer”. IEEE Photonics Technology Letters 30.3 (2017): 281-284.
[10] Patent Application WO2018/104725 A1 (Yan et al.), 2017.
[11] Patent Application US2013/121,698 A1 (Li et al.), 2013.
[12] Patent Application US2017/205,585A1 (Takahashi), 2017.
[13] Patent Application US2014/140,694A1 (Zhou et al.), 2014.
[14] Patent Application WO2012/092174A1 (Doerr et al.), 2012.

### BRIEF DESCRIPTION OF THE FIGURES

FIG. 1: Diagram of the device's operating principle, where (i) corresponds to fiber 1 and (ii) to fiber 2.

FIG. 2: Schematic of a generic implementation of the method and device presented for a 4-core multi-core fiber-based system.

FIG. 3: Laboratory implementation scheme of the device for 4-core fibers, where (iii) corresponds to the signal/switch control.

FIG. 4: Example of implementation of the spatial mode division and combination modules.

FIG. 5: Example of graphs of output nucleus intensities with the stabilized system, where (5.1) corresponds to core 1, (5.2) to core 2, (5.3) to core 3 and (5.4) to core 4.

### DESCRIPTION OF THE INVENTION

The present technology is a method and a device for switching at high speed a signal propagating from a n core in a first fiber of the multi-core type to a m core in a second fiber from a second multi-core fiber.

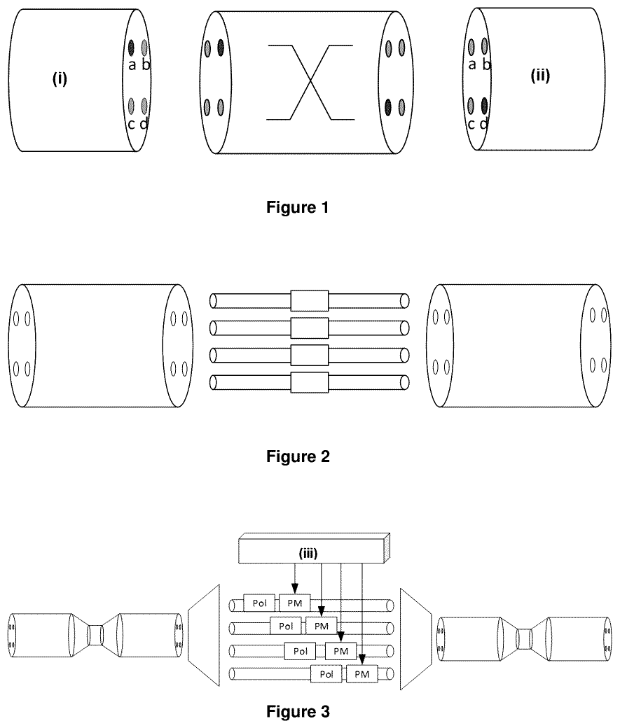

For a better understanding of the invention, FIG. 1 is taken as a reference, which shows the principle of operation of the device, and FIG. 2, which shows a generic implementation of the method and device presented for a system based on 4-core multi-core fibers. Specifically, FIG. 1 shows the operation of the device in a system formed by a multi-core optical fiber input, an output fiber, as well as a switching device. Also, it is possible to observe an optical signal that is propagated by a first multi-core fiber through the b-index core. The signal enters the multi-core fiber-based switching device through the b-index core. Inside the device, the signal propagation core is switched and at the output of the device the signal propagates through the c-index core. In turn, the output of the device is connected to a second multi-core fiber, prepared to propagate the fiber through the new core. Wherein the input, output fibers, and the device can contain at least 2 cores.

More particularly, the device for high-speed switching a signal is composed in its simplest form of at least the following components, as shown in FIG. 2:
a.—a module for the division of spatial modes,
b.—a module for combining spatial modes, and
c.—a phase modulation module.

The spatial mode division module is responsible for splitting the input signal or signals into multiple spatial modes confined in a single multi-core fiber. At the output of this module, each spatial mode of the device must have a copy of the signal or signals to be switched. The spatial mode combination module is used to gather all the copies of the signals propagating in the device and realize the interference effect between them. Both modules, the division and the spatial mode combination module, can be built based on multi-core fibers.

On the other hand, the modulation module is responsible for applying certain phases to each of the spatial modes of the system to manipulate the interference effect between the spatial modes in the spatial mode combination module, and in this way, the output port of the signal to be switched can be determined. This module must be developed in a system capable of guiding optical signals and applying phase changes on them. This module can preferably be made based on rectangular waveguides or optical fibers.

The method of operating the device for high-speed switching of a signal comprises at least the following stages:
Coupling to device cores: The optical signal or signals at the output of a multi-core fiber are connected directly to the device, allowing signals to enter through the device's input port into a spatial mode of the spatial mode division module. The output of the spatial mode division module then consists of N copies of the original signal in each of the device's spatial modes. Where, the spatial modes have a phase and amplitude relationship between them that depends on the multiplicity N of the implementation of the spatial mode division module;
b.—Phase modulation: the optical signals replicated in N spatial modes enter this stage, where each of the spatial modes can receive a certain phase. The phase delivered to each of the spatial modes can be selected by the device operator to determine the switching to be performed. The way to control the phases depends directly on the implementation of this stage, which can be, but is not limited to, using electro-optical phase modulators or a photonic circuit based on waveguides capable of controlling their refractive index based on voltages, where the voltage ranges for electro-optical modulator operation vary from −5 to 5 [V]. The method used for the implementation of this stage determines the maximum spatial switching speed. Maximum switching speeds are determined by the components used, which can have bandwidths of up to 90 GHz considering state-of-the-art technology. This corresponds to a switching speed of 11 ps. Optionally, for electro-optical modulator-based implementations, a polarization control stage can be added before the modulator to optimize device operation;
c.—Interference generation: The output of the phase modulation module must be connected directly to the spatial mode combination module, where the connection between the phase control module and the spatial mode combination module depends directly on the implementation of the former. Where the spatial mode combination module is responsible for combining the N spatial modes present in the device. The spatial mode combination module has a number of spatial modes equal to M; and where the number of spatial modes of the division and combination modules (N and M) can be equal. When combining the spatial N modes, the multipath interference effect occurs. The relative phase of each of the N spatial modes determines the intensity that the modes will have in each core at the output of the spatial mode combination module; and
Output core selection: To select the output core of the device, a certain set of phases must be applied to the phase modulation module, where the signal to the output of the spatial mode combination module must be connected directly to the second multi-core fiber. The set of phases must be selected by the user and depends on the spatial module of the device's output. The phases can be generated by an electronic or digital system and connected to the phase modulation stage via a digital-analog converter device.

Depending on the implementation selected for the phase modulation stage, optionally, a control system can be implemented to stabilize the phase fluctuations present in the system. The stabilization system has the function of correcting phase fluctuations that may exist due to environmental variables such as fluctuations in temperature, mechanical vibrations, differences in the length of the paths, among others.

Finally, this technology allows a signal to be switched at high speed in communications systems based on multi-core fibers and where advantageously no free space optics are required to perform such switching.

### Application Example

For this realization, FIG. 3 is taken as a reference, which shows an implementation of the device to switch signals spatially in 4-core fibers. The device was composed of a spatial division module, a spatial demultiplexer, manual polarization controllers, opto-electronic phase modulators, a spatial multiplexer, and a spatial combination module. The aforementioned modules were connected sequentially in the order described. All modules used were built on optical fibers and the connections between modules were made using mechanical fiber optic adapters. The spatial mode splitting and combining modules were manufactured with multi-core fiber-based devices capable of acting as a signal splitter and combiner.

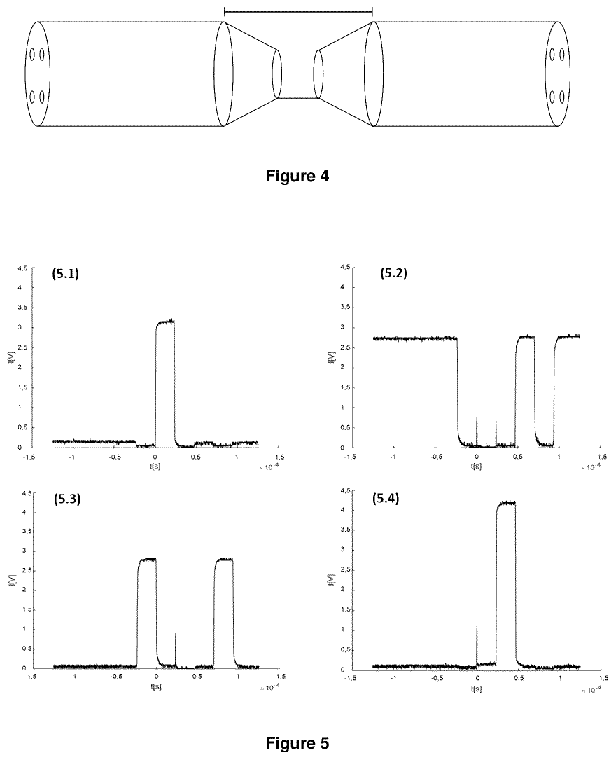

Specifically, FIG. 4 shows the implementation used for the split and combination modules, which were made using the optical fiber tapering technique. This is a conventional process for the manufacture of telecommunications combiners, which consists of bringing the cores closer together of two or more optical fibers by a process of stretching their ends and heating their midsection. As can be seen in this figure, the midsection of the splitter/combiner presents an approximation between the 4 cores of the fiber. Where the devices were manufactured using multi-core fibers with 4 cores distributed homogeneously, in addition the cores were not covered with trenches. Both devices were able to split the input signal in a spatial mode into 4 copies with the same intensity, i.e. at the output of the devices the 4 spatial modes had the same optical power.

Moreover, the phase control module was built based on commercial electro-optical modulators with an analog bandwidth of 10 Ghz, which limited the switching speed to 0.1 ns and, in addition, 3 phase modulators in total were used for this module. The phase modulators were controlled by voltage signals with a range between −5 and 5 V to make changes in the phase of the optical signals. The phase modulators contained a polarizer inside. Also, manual bias controllers were used to ensure maximum transmission of the signals through the phase modulators. Alternatively, the phase control module can be implemented using a waveguide-based photonic circuit.

Both the connection between the spatial mode division module and the phase modulation module and the connection of the phase modulation module with the spatial combination module were made through spatial multiplexers. The spatial multiplexers consisted of 4 optical fibers that were coupled to a 4-core multi-core fiber using a tapering process.

For the operation of the device, a control system was used to stabilize the phase of the signals in each of the spatial modes/paths of the phase control module. The phase control was performed using an FPGA card. The same FPGA card was used for the manipulation of the switching performed by the device. The inputs and outputs of the card corresponded to analog/digital and digital/analog converters. The analog/digital converters were responsible for converting the output of the switch to a digital signal to be processed by the FPGA card. The digital/analog converters were responsible for converting the digital stabilization signal into a voltage signal capable of acting on the phase modulation module. The stability voltages were applied by adding them over the control voltages of the device. In this way, the sum of two voltages was applied to the phase modulators, one of them being in charge of stabilizing the device and the other of performing the switching.

The results obtained by operating the device were:

### System Stabilization

To stabilize the system, a signal generated by an optical source was injected into an input core of the device. The signal consisted of the continuous emission of a distributed feedback laser centered at 1550 nm. The signal polarization was adjusted to achieve the greatest transmission through the system components on each of the paths.

The control system operated as follows: the signal intensity in each of the device's output cores was detected using four photodiodes, one for each core and then digitized by the analog-to-digital converters. The converters sent the information to the FPGA card. The control algorithm, called Maximum Point Power Tracking (MPPT), was executed in real time on the card. The algorithm generated three digital output signals, which were transformed into analog voltage outputs by digital-analog converters. The voltage signals acted on the phase modulators. The algorithm was responsible for maximizing the intensity in one of the output cores of the device, while in the other 3 cores the intensity was minimized. The control algorithm was able to keep the intensity stable in all outputs of the device. FIG. 5 shows the intensities of the four output nuclei with the stabilized system, where the stability in the output intensities can be observed.

### 25 us Switching

With the stabilized device, the signal was switched to different output cores. To do this, the FPGA card generated three digital signals synchronously responsible for determining the output of the system. These signals were converted to voltage signals by analog digital converters, and then the analog signals were added with stabilization using an analog circuit. The output was switched from the input core to each of the output cores. The switching duration to each core was 25 us. As mentioned above, FIG. 5 shows the intensities of the four output cores during the switching process.

Based on these results, the device was characterized based on the attenuation introduced to the input signal (insertion loss) and the inter-core interference generated in the device at the switching speed. These results are reported in Table 1 and Table 2, where insertion loss and inter-core cross-talk were calculated based on the result in FIG. 5. Advantageously, with this method it was possible to switch a core at high speed, with low loss and low interference of a signal in multi-core fibers.

TABLE 1
Insertion Loss for 25 us Switch

| Check-in - | | | | |
|---|---|---|---|---|
| Check-out | Core 1 | Core 2 | Core 3 | Core 4 |
| Core 2 | −4.4[dB] | −4.9[dB] | −4.9[dB] | −3.2[dB] |

TABLE 2
Inter-core cross-talk for 25 us switch

| Check-in - | | | | |
|---|---|---|---|---|
| Check-out | Core 1 | Core 2 | Core 3 | Core 4 |
| Core 1 | — | −20.7 [dB] | −14.3 [dB] | −12.8 [dB] |
| Core 2 | −12.4 [dB] | — | −16.2 [dB] | −13.8 [dB] |
| Core 3 | −16.7 [dB] | −14.1 [dB] | — | −15.4 [dB] |
| Core 4 | −18.5 [dB] | −18.1 [dB] | −21.9 [dB] | — |

1-5. (canceled)

6. A device for high-speed switching of a signal propagating in a n core in a first multi-core fiber to a m core in a second multi-core fiber comprising at least the following components:
a spatial mode division module, responsible for dividing the input signal or signals into multiple spatial modes confined in the first multi-core fiber; and at an output, consisting of N copies of an original signal in each of the spatial modes of the device, wherein each spatial mode of the device have N copies of the signal or signals to be switched;
a spatial mode combination module, provided with a number of spatial modes equal to M, wherein N and M are equal, used to gather all the copies of the signals propagating in the device and perform interference between them; the spatial mode combination module is constructed using a narrowed MCF fiber using multicore fibers taper technique; the number of spatial modes of the split and merge modules must be equal;
a phase modulation module that is responsible for applying certain phases to each of the spatial modes resulting from the spatial mode division module; each of the spatial modes of the system circulates through an electro-optical phase modulator and where the phase of each spatial mode is controlled by a voltage applied to the waveguide connected to the modulator using a digital-analog converter device; This is used to manipulate the interference effect between the spatial modes in the spatial mode combination module, to determine the output port of the signal to be switched; where each phase is generated by an electronic or digital system; and
an input port to a spatial mode of the spatial mode division module.

7. The device for high-speed switching of a signal according to claim 6, wherein the spatial mode division module and the spatial mode combination module are made from multi-core fibers.

8. A method for operating the device a high-speed switching of a signal according to claim 6, comprising at least the following steps:
coupling to the cores of the device: connecting the optical signal or signals to the output of a multi-core fiber directly with the device, allowing the signals to enter through the input port of the device to a spatial mode of the spatial mode division module; the output of the spatial mode division module consists of N copies of the original signal in each of the device's spatial modes; wherein the spatial modes have a phase and amplitude relationship between them that depends on the multiplicity N of the implementation of the division module of the spatial modes;
phase modulation: having the optical signals replicated in N spatial modes enter this stage, wherein each of the spatial modes receives a certain phase; wherein the phase delivered to each of the spatial modes is selected from the device to determine the switching to be performed; and wherein the phases are controlled by electro-optical phase modulators or a photonic circuit, wherein the phase of each spatial mode is controlled by a voltage applied to the waveguide; and where the implementation method determines the maximum spatial switching speed;
interference generation: connecting the output of the phase modulation module directly to the spatial mode combination module, wherein the connection between the phase control module and the spatial mode combination module depends directly on the implementation of the former; and wherein the spatial mode combination module combines the N spatial modes present in the device; wherein the spatial mode combination module has a number of spatial modes equal to M; and wherein the number of spatial modes of the division and combination modules are equal; when combining the spatial N modes in the spatial mode combination module, a multipath interference effect occurs when propagating through the combination module; and the relative phase between each of the N spatial modes determines the intensity that the modes will have in each core at the output of the spatial mode combination module; and
output core selection: selecting an output core of the device by having a certain set of phases applied in the phase modulation module, wherein the signal at the output of the spatial mode combination module is connected directly to the second multi-core fiber and depends on the spatial module of the device's output and wherein the phases are generated by an electronic or digital system and connected to the phase modulation stage through a digital-analog converter device.

9. The method for operating the device a high-speed switching of a signal according to claim 8, wherein in stage “b” a control system is added to stabilize phase fluctuations present in the system.
